(19) United States
(12) Patent Application Publication
(10) Pub. No.: US 2022/0095555 A1
(43) Pub. Date: Mar. 31, 2022

(54) HORTICULTURAL FILL

(71) Applicant: Better Trick, Inc., Columbus, NE (US)

(72) Inventors: James William KRAMER, Columbus, NE (US); Daniel Stephen JONES, Leominster, MA (US); Joel LIEBLEIN, Greenfield, MA (US); Steven DRAKE, Concord, MA (US)

(73) Assignee: Better Trick, Inc., Columbus, NE (US)

(21) Appl. No.: 17/486,601

(22) Filed: Sep. 27, 2021

Related U.S. Application Data
(60) Provisional application No. 63/083,987, filed on Sep. 27, 2020.

(51) Int. Cl. A01G 24/40; A01G 24/30; B65D 65/46

(52) U.S. Cl. CPC A01G 24/40; B65D 65/466; A01G 24/30

(57) ABSTRACT

A horticultural fill system comprises a biodegradable outer packaging and a plurality of biodegradable bipyramidal horticultural fill elements. The plurality of biodegradable bipyramidal horticultural fill elements are removably disposed within the biodegradable outer packaging, and a group of the plurality of biodegradable bipyramidal horticultural fill elements is configured to be positioned in a horticultural planter container, as horticultural fill, beneath growth medium in which a plant is to be grown.

### CROSS REFERENCE TO RELATED APPLICATIONS

This application claims priority to and benefit of provisional patent application, Ser. No. 63/083,987, Attorney Docket Number TRICK-001-PR, entitled “Horticultural Fill,” by James Kramer et al., with filing date Sep. 27, 2020, which is herein incorporated by reference in its entirety.

### BACKGROUND

Modern living habits have encouraged an increase in the display of attractive potted plants and home-grown herbs and vegetables. Horticultural planter containers such as garden pots, windowsill planters, hanging basket planters, and others are used by horticulturalists to grow a variety of plants. A horticultural planter container is a structural container which holds growth matter, such as potting soil or dirt, into which seeds or living plants are placed and nurtured. Horticultural planter containers with attractive plantings are commonly displayed in many settings to provide color and a natural aesthetic to modern human environments; to grow fruits and vegetables; and/or to promote pollinating insects.

### BRIEF DESCRIPTION OF DRAWINGS

The accompanying drawings, which are incorporated in and form a part of the Description of Embodiments, illustrate various embodiments of the subject matter and, together with the Description of Embodiments, serve to explain principles of the subject matter discussed below. Unless specifically noted, the drawings referred to in this Brief Description of Drawings should be understood as not being drawn to scale. Herein, like items are labeled with like item numbers.

FIG. 1A illustrates a front elevational view of an example biodegradable horticultural fill element; the rear elevational view is the same.

FIG. 1B illustrates a top plan view of the example biodegradable horticultural fill element shown in FIG. 1A; the bottom plan view is the same as FIG. 1B.

FIG. 1C illustrates a right side elevational view of the example biodegradable horticultural fill element shown in FIG. 1A; the left side elevational view is the same as FIG. 1C.

FIG. 1D illustrates an upper front right perspective view of the example biodegradable horticultural fill element shown in FIG. 1A.

FIG. 2A illustrates a front elevational view of an example biodegradable horticultural fill element; the rear elevational view is the same.

FIG. 2B illustrates a top plan view of the example biodegradable horticultural fill element shown in FIG. 2A; the bottom plan view is the same as FIG. 2B.

FIG. 2C illustrates a right side elevational view of the example biodegradable horticultural fill element shown in FIG. 2A; the left side elevational view is the same as FIG. 2C.

FIG. 2D illustrates an upper front left perspective view of the example biodegradable horticultural fill element shown in FIG. 2A.

FIG. 3A illustrates a front elevational view of an example biodegradable horticultural fill element; the rear elevational view is the same.

FIG. 3B illustrates a top plan view of the example biodegradable horticultural fill element shown in FIG. 3A; the bottom plan view is the same as FIG. 3B.

FIG. 3C illustrates a right side elevational view of the example biodegradable horticultural fill element shown in FIG. 3A; the left side elevational view is the same as FIG. 3C.

FIG. 3D illustrates an upper front left perspective view of the example biodegradable horticultural fill element shown in FIG. 3A.

FIG. 4A illustrates a front elevational view of a horticultural planter container with a flower planted and growing in growth medium disposed within the horticultural planter container; wherein section line A-A, marks the location and direction of a sectional side view.

FIG. 4B illustrates one version of a left side elevational section A-A, in which the horticultural planter container is filled entirely with growth matter as may be done conventionally.

FIG. 4C illustrates a second version of left side elevational section A-A, in which the horticultural planter container is filled partially with a plurality of biodegradable horticultural fill elements that are disposed loosely at the bottom of horticultural planter container.

FIG. 4D illustrates a third version of left side elevational section A-A, in which the horticultural planter container is filled partially with a plurality of biodegradable horticultural fill elements that are disposed loosely at the bottom of horticultural planter container.

FIG. 4E illustrates a fourth version of left side elevational section A-A, in which the horticultural planter container is filled partially with a plurality of biodegradable horticultural fill elements that are strung upon a biodegradable string and disposed at the bottom of horticultural planter container.

FIG. 4F illustrates a fifth version of left side elevational section A-A, in which the horticultural planter container is filled partially with a plurality of biodegradable horticultural fill elements that are confined within a bag and disposed at the bottom of horticultural planter container.

FIG. 4G illustrates a sixth version of left side elevational section A-A, in which the horticultural planter container is filled partially with a plurality of biodegradable horticultural fill elements that are confined within a bag and disposed at the bottom of horticultural planter container.

FIG. 4H illustrates a seventh version of left side elevational section A-A, in which the horticultural planter container is filled partially with a plurality of biodegradable horticultural fill elements that are confined within a bag and disposed at the bottom of horticultural planter container.

FIG. 4I illustrates an eighth version of left side elevational section A-A, in which the horticultural planter container is filled partially with a plurality of biodegradable horticultural fill elements that are both strung on a biodegradable string and confined within a bag before being disposed at the bottom of horticultural planter container.

FIG. 4J illustrates a ninth version of a left side elevational section A-A, in which the horticultural planter container is filled partially with a plurality of biodegradable horticultural fill elements that are strung upon a biodegradable string and disposed at the bottom of horticultural planter container.

FIG. 4K illustrates tenth version of a left side elevational section A-A, in which the horticultural planter container is filled partially with a plurality of biodegradable horticultural fill elements that are both strung on a biodegradable string and confined within a bag before being disposed at the bottom of horticultural planter container.

FIG. 5A illustrates a top plan view of recyclable or biodegradable outer packaging which contains a plurality of biodegradable horticultural fill elements along with one or more of a biodegradable string and a bag to form a stock-keeping unit (SKU).

FIG. 5B illustrates a top plan view of recyclable or biodegradable outer packaging which contains a plurality of biodegradable horticultural fill elements along with a bag to form a stock-keeping unit (SKU).

FIG. 5C illustrates a top plan view of recyclable or biodegradable outer packaging which contains a plurality of biodegradable horticultural fill elements along with one or more of a bag to form a stock-keeping unit (SKU).

FIG. 6A illustrates a front elevational view of an example biodegradable horticultural fill element; the rear elevational view is the same.

FIG. 6B illustrates a right side elevational view of the example biodegradable horticultural fill element shown in FIG. 6A; the left side elevational view is the same as FIG. 6B.

FIG. 6C illustrates an upper front right perspective view of the example biodegradable horticultural fill element shown in FIG. 6A; the upper front left perspective view is a mirror image of FIG. 6C.

FIG. 7A illustrates a front elevational view of an example biodegradable horticultural fill element; the rear elevational view is the same.

FIG. 7B illustrates a right side elevational view of the example biodegradable horticultural fill element shown in FIG. 7A; the left side elevational view is the same as FIG. 7B.

FIG. 7C illustrates an upper front right perspective view of the example biodegradable horticultural fill element shown in FIG. 7A; the upper front left perspective view is a mirror image of FIG. 7C.

FIG. 8A illustrates a front elevational view of an example biodegradable horticultural fill element; the rear elevational view is the same.

FIG. 8B illustrates a right side elevational view of the example biodegradable horticultural fill element shown in FIG. 8A; the left side elevational view is the same as FIG. 8B.

FIG. 8C illustrates an upper front right perspective view of the example biodegradable horticultural fill element shown in FIG. 8A; the upper front left perspective view is a mirror image of FIG. 8C.

### DESCRIPTION OF EMBODIMENTS

Reference will now be made in detail to various embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications and equivalents, which may be included within the spirit and scope the various embodiments as defined by the appended claims. Furthermore, in this Description of Embodiments, numerous specific details are set forth in order to provide a thorough understanding of embodiments of the present subject matter. However, embodiments may be practiced without these specific details. In other instances, well known methods, procedures, and components have not been described in detail as not to unnecessarily obscure aspects of the described embodiments.

### Overview of Discussion

Once seeds or plants are planted in growth matter disposed in a horticultural planter container, on-going care is required to maintain beneficial growth matter conditions, proper moisture, required nutrients, and protection from detrimental environmental conditions such as inclement weather and damaging changes in temperature. Such care can often involve relocating the horticultural planter container and its contents to a safe location and then moving it back to its original location once the inclement weather has passed. This can happen many times in a growing season. The relocation can be quite taxing for a horticulturalist as horticultural planter containers can be heavy and unwieldy when filled completely with growth matter, and the weight and unwieldiness can be compounded when the growth matter is saturated with water, nutrients, herbicides, pesticides, fertilizers, and/or additives. Medium to large garden pot type horticultural planter containers require substantial quantities of growth matter, such as potting soil, to fill them. Even in small garden pots the growth matter provides the majority of the overall weight of the planted container. Once filled with soil and plantings, horticultural planter containers can be unduly heavy, cumbersome, and consequently difficult to move. The weight and unwieldiness can provide safety issues (e.g., strained muscles, tripping), especially for smaller and/or elderly horticulturalists. The weight and unwieldiness can also result in dropping or otherwise damaging horticultural planter containers during relocation.

In many instances, in order to reduce the amount of growth medium required, some type of fill may be placed beneath the growth medium. Conventionally, this fill may consist of materials such as sand, rocks, broken glass, expanded polystyrene packing material, used aluminum beverage cans, used plastic bottles, and/or pottery shards. Such conventional fill may reduce the amount of growth medium deposited in the container, but it can add a similar or greater weight than growth matter which is displaced. Such conventional fill material may also be difficult to separate from the growth matter at the end of the growing season when the horticultural planter container is emptied and placed in storage. In other instances, this conventional fill material may be difficult to clean before it is disposed, stored, or reused. In yet other cases, due to sharp edges/cutting hazards, this conventional fill material may be dangerous to separate from growth material. In still other cases, the conventional fill material is either not biodegradable or else not biodegradable in an environmentally meaningful/useful timeframe (i.e., it may take hundreds of years to biodegrade).

The horticultural fill elements and systems described herein provide new and useful methods for less physically taxing, more environmentally conscious horticulture. Herein, various embodiments are described that provide biodegradable horticultural fill elements, horticultural fill systems, and horticultural fill methods of use that facilitate improvements which may include, one or more of: reducing the weight of a planted horticultural planter container; providing horticultural fill which is light in weight compared to displaced growth matter; providing horticultural fill which is reusable; providing a horticultural fill system with one or more biodegradable components; providing biodegradable horticultural fill elements which biodegrade in predetermined time period which is less than 20 years; easing separation of horticultural fill material from growth matter; eliminating sharp edges and cutting hazards in horticultural fill material; and reducing or eliminating cleaning of horticultural fill material prior to storage, reuse, and/or disposal.

Discussion begins with description of some example biodegradable horticultural fill elements which may also be referred to as “inserts” or “horticultural inserts.” Some discussed examples are made of plastic. The plastic horticultural fill elements may be made of plastic resin(s) designed to biodegrade in less than 20 years and/or in a predetermined number of years. Other discussed examples of biodegradable horticultural fill elements are made of segmented bamboo, which is naturally biodegradable. Discussion continues with description of methods and/or systems of use of the biodegradable horticultural fill elements with horticultural planter containers. Discussion concludes with description of a variety of alternative polyhedral shapes for biodegradable horticultural fill elements.

### Example Plastic Biodegradable Horticultural Fill Elements

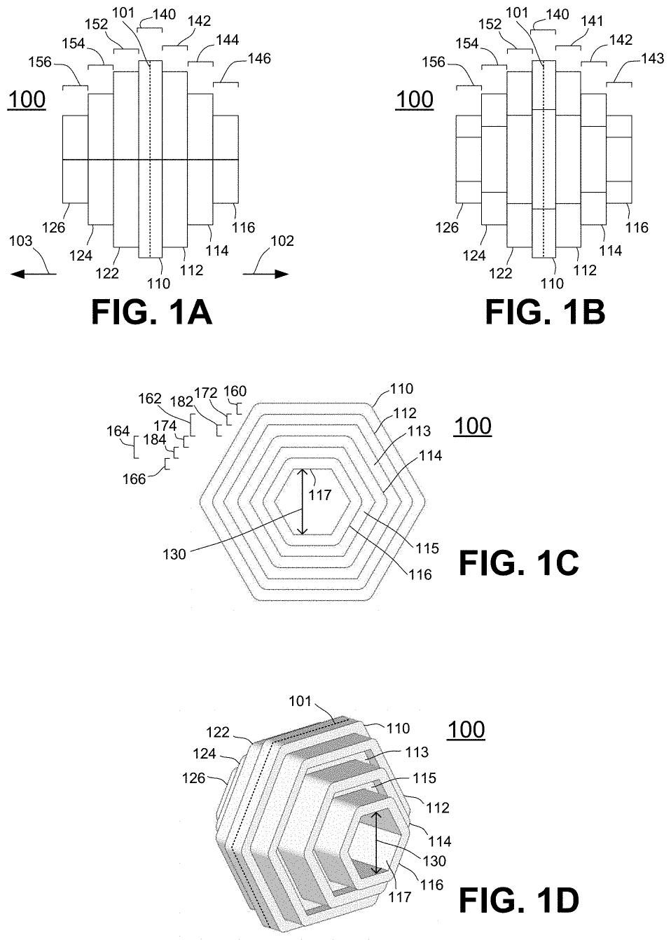

FIG. 1A illustrates a front elevational view of an example biodegradable horticultural fill element 100. The rear plan elevational is the same as FIG. 1A.

FIG. 1B illustrates a top plan view of the example biodegradable horticultural fill element 100 shown in FIG. 1A. The bottom plan view is the same as FIG. 1B.

FIG. 1C illustrates a right side elevational view of the example biodegradable horticultural fill element 100 shown in FIG. 1A. The left side elevational view is the same as FIG. 1C.

FIG. 1D illustrates an upper front right perspective view of the example biodegradable horticultural fill element 100 shown in FIG. 1A. The upper front left perspective view is a mirror image of FIG. 1D.

Biodegradable horticultural fill element 100 of FIGS. 1A-1D is hexagonally shaped, but the shape is not so limited. In other embodiments, as described and depicted herein, a variety of other rounded and/or polyhedral shapes may be employed as base shapes for a biodegradable horticultural fill element. Biodegradable horticultural fill element 100 can be considered “structural” due to having low compressibility under load from any direction. Biodegradable horticultural fill element 100 weighs substantially less than a volume of plant growth matter, such as dirt or potting soil, which it displaces and does not absorb water in a manner which materially increases its weight.

Generally, a biodegradable horticultural fill element 100 comprises a central polyhedral shape with at least three sides and preferably six sides (as depicted in FIGS. 1A-1D). Other numbers of sides for the central polyhedral shape are anticipated and possible, such as four sides, five sides, seven sides, eight sides, nine sides, etc. In FIGS. 1A-1B, this central polyhedral shape is a hexagonal ring 110. As depicted in FIGS. 1A and 1B, the width 140 of the central polyhedral shape 110 may be symmetrically centered on an injection molding mold parting line 101. A first plurality of progressively smaller polyhedral shapes (112, 114, 116) is stair-step stacked upon the central polyhedral shape 110, in a first direction 102, from the mold parting line. Although a plurality of three progressively smaller polyhedral shapes 112, 114, and 116 are depicted, the plurality may be a little as two or a higher number than three, such as four, five, six, seven, etc. A second plurality of progressively smaller polyhedral shapes (122, 124, 126) is stair-step stacked upon the central polyhedral shape 110, in a second direction 103, from the mold parting line 101. The second direction 103 is opposite of the first direction 102. As depicted, the stacked polyhedrons are all of the same type as the central polyhedral shape 110 and have their vertices aligned with the vertices of central polyhedral shape 110. However, neither of these features is required. The stairstep-stacked polyhedral shapes may have equal wall thickness to one another, but this is not required.

Using, for convenience, terminology for components of actual stair steps, each stair step in FIGS. 1A-1D comprises a tread and a riser. The width of a stair step in FIG. 1A is referred to herein as a tread width, while the span between the tread of one stair step and the tread of an adjacent stair step in FIG. 1A is referred to herein as a riser height. Tread widths 140, 142, 144, 146, 152, 154, and 156 are annotated in FIGS. 1A and 1B. Riser heights 160, 162, and 164 are annotated in FIG. 1C. In some embodiments, riser height 160 is equivalent to the wall thickness of polyhedral shape 110, while in other embodiments the relationship between wall thickness and riser height may be different. Moats (113, 115, etc.) are recessed regions between stair-stepped polyhedral shapes that may be utilized, in some embodiments, to further increase external surface area of biodegradable horticultural fill element 100. In an embodiment where moats are utilized, riser height 162 is the wall thickness 172 of polyhedral shape 112 plus the moat width 182 of the recessed moat 113 between the inner wall of polyhedral shape 112 and the outer wall of polyhedral shape 114. In an embodiment where moats are utilized, riser height 164 is the wall thickness 174 of polyhedral shape 114 plus the moat width 184 of the recessed moat 115 between the inner wall of polyhedral shape 114 and the outer wall of polyhedral shape 116. Riser height 166 is equivalent to the wall thickness of polyhedral shape 116. In some embodiments, where moats are utilized, wall thicknesses and moat widths are equal distances.

In some embodiments, a central thru hole 130 is defined, within the biodegradable horticultural fill element 100, by the common inner wall 117 shared by the inner most polyhedral shapes 116 and 126. Thru hole 130 forms a tunnel between the smallest polyhedral shape 116 of the first plurality of progressively smaller polyhedral shapes and the smallest polyhedral shape 126 of the second plurality of progressively smaller polyhedral shapes. Thru hole 130, when included, increases the surface area of biodegradable horticultural fill element 100.

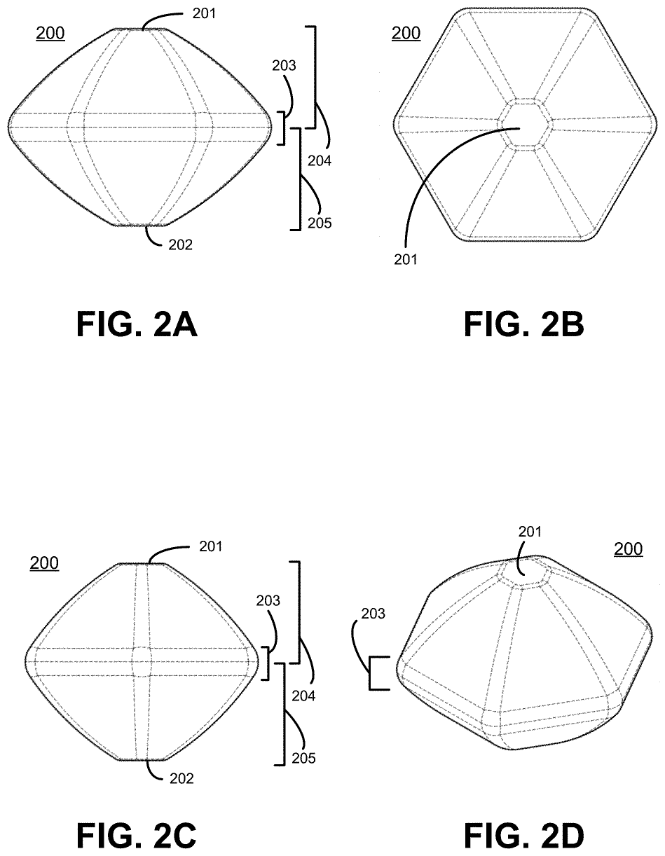

FIG. 2A illustrates a front elevational view of an example biodegradable horticultural fill element 200; the rear elevational view is the same. The flattened/truncated vertex 201 at the apex is illustrated as is the flattened/truncated vertex 202 at the base.

FIG. 2B illustrates a top plan view of the example biodegradable horticultural fill element 200 shown in FIG. 2A; the bottom plan view is the same as FIG. 2B.

FIG. 2C illustrates a right side elevational view of the example biodegradable horticultural fill element 200 shown in FIG. 2A; the left side elevational view is the same as FIG. 2C.

FIG. 2D illustrates an upper front left perspective view of the example biodegradable horticultural fill element 200 shown in FIG. 2A.

With reference to FIG. 2A, biodegradable horticultural fill element 200 is a polyhedron and may be described as a pair of hexagonal pyramids coupled base to base, but with rounded edges and peaks. It may also be described as a hexagonal bipyramid (or other bipyramid) which is slightly truncated (i.e., flattened or rounded). This shape provides a high surface area and cannot roll away if dropped, placed or spilled on a surface, or blown by a breeze. In other embodiments, as described and depicted herein, a variety of other rounded/slightly truncated polyhedral bipyramidal shapes may be employed as base shapes for a biodegradable horticultural fill element. Generally, a biodegradable horticultural fill element 200 comprises a bipyramidal polyhedral shape with at least three sides to its pyramids and preferably six sides to its pyramids (as depicted in FIGS. 2A-2D). Other numbers of sides for the pyramids are anticipated and possible, such as four sides, five sides, seven sides, eight sides, nine sides, etc. In some embodiments, the edges of the bipyramids and the join region 203 of the bipyramids are chamfered, beveled, or rounded to reduce sharp corners and edges which might otherwise cut the hand of a gardener or puncture a bag or container. Though not depicted, in some embodiments, a central thru hole may be molded between the truncated caps/vertexes 201 and 202 of the two pyramids which form the top and bottom of the bipyramidal shape. That is, in some embodiments, a thru hole is defined between a first vertex 201 of a first pyramid 204 of the bipyramidal shaped polyhedron and a second vertex 202 of the second pyramid 205 of the bipyramidal shaped polyhedron.

Biodegradable horticultural fill element 200 can be considered “structural” due to having low compressibility under load from any direction. Biodegradable horticultural fill element 200 weighs substantially less than a volume of plant growth matter, such as dirt or potting soil, which it displaces. In some embodiments, biodegradable horticultural fill element 200, does not absorb water in a manner which materially increases its weight. As depicted, biodegradable horticultural fill element 200 lacks sharp edges and sharp corners, and thus reduces or eliminates risks of cutting/abrasion which may occur when handling biodegradable horticultural fill element 200 (as compared to some conventional horticultural fill such as rocks or shards).

In some embodiments, one or both of biodegradable horticultural fill elements 100 and 200 may be formed of injection molded plastic which is composed essentially of a plastic resin such comprising a polymer and an amount of between about 1% and 5% of oxidizing additives (by weight). In various embodiments, the polymer portion is any suitable polymeric resin such as polystyrene, polyethylene, polypropylene, polyethylene terephthalate, or other suitable injection moldable polymer resin (e.g., thermoplastic resin). The oxidizing additives are typically one or some combination of metal salts. The salt or salts used may vary based on the polymer used. Some examples of salt(s) which may be used as oxidizing agents in the plastic resin include, but are not limited to, commercially available additives from Willow Ridge Plastics, Incorporated (e.g., PDQ-M, PDQ-H, BDA, OxoTerra™) or another oxo-biodegradable additive manufacturers. The additive(s) act as prodegradant catalysts and may include one or more transition metals (or a metallic salt thereof) such as cobalt (Co), magnesium (Mg), or manganese (Mn), zinc (Zn), iron (Fe), or nickel (Ni). Incorporation of the additive(s) into the resin introduces metal ions into the polymer that are susceptible to light, heat, moisture, and mechanical stress and as such, weaken the tensile strength of the polymer chain. Once components of the plastic resin are combined, the resulting injection molded plastic is an oxo-biodegradable plastic. In the oxo-biodegradation process, time, ambient heat, and/or ultraviolet light, will oxidize the injection molded plastic. Oxidation reduces the molecular weight of the plastic and allows for oxygen containing functional groups to form within the polymer. Both the air and sunlight cause an oxidative chain scission that can be catalyzed with the presence of metallic salts/metallic ions in an oxo-degradable additive. Low volatile carboxylic acids (C3-C24) are generated in the decomposition process. This allows microorganisms to further biodegrade the polymer once it has been disposed. For example, these leftover low molecule compounds can then be consumed by microscopic bacteria and fungi. In turn, they naturally remove plastic from the environment by converting it into carbon dioxide, water, and/or other basic components.

The oxidizing additives are formulated to encourage growth of microorganisms within the molecular structure of the polymeric resin at a predetermined rate, resulting in time-controlled biodegradation of the plastic resin. The timing and rate of controlled biodegradation of the plastic resin is controlled by the quantity of oxidizing compound incorporated into the polymeric resin at the time of molding. The amount and type of the oxidizing additives is purposely selected to choose a first time span over which the injection molded plastic will provide a useful life after production and before beginning to biodegrade enough that it cannot be readily used for its purpose. After the first time span associated with the useful life, the plastic resin will then fully biodegrade over a second time span of 1 to 3 times the useful life (e.g., if the useful life is 5 years, the polymeric resin will fully biodegrade 5 to 15 years after the useful life ends). In some embodiments, the first time span is selected to be between 1 and 10 years for the useful life. For example, the span first time span may be selected to be approximately 3 years, approximately 4 years, approximately 5 years, etc. or may be selected to fall between in a certain range such as 3 to 6 years, years, 5 to 8 years etc. The biodegrading occurs via oxidation of the plastic resin, which is caused by the oxidizing additives. The oxidation begins to occur after injection molding has taken place and gradually deteriorates the structure of the plastic such that bacteria in the environment can more readily intrude the structure and breakdown the plastic. The amount (i.e., the percentage) of the oxidizing additives in the overall plastic resin has an inverse relationship with the useful lifespan and the overall time of biodegradation. That is, a larger percentage of oxidizing additives in the plastic resin results in a shorter time over which the injection molded plastic will biodegrade. Conversely, a smaller percentage of oxidizing additives in the plastic resin results in a longer time over which the injection molded plastic will biodegrade. Put differently, the oxidation rate of the polymer can be adjusted by increasing the loading of the oxidizing additive. Thus, the first time span (i.e. the useful life), the second time span (full biodegradation), or both may be defined by the amount and/or type of additives which are included. In some embodiments, a single additive may be utilized to selectively control and accelerate biodegradation (in comparison to a similar plastic without the additive). In some embodiments, two or more additives may be used in combination to selectively control and accelerate biodegradation (in comparison to a similar plastic without the additives). Even when made to be biodegradable, such foam may be generally resistant to incursion of water/moisture such that it does not become waterlogged.

In some embodiments, one or both of biodegradable horticultural fill elements 100 and 200 may be formed of molded foam. That is, the horticultural fill element would be a foam internally with a skin on any outer surface. A variety of foamed plastic resins may be utilized in the foam molding, such as, but not limited to: EVA (ethylene vinyl acetate) foam and polypropylene foam. The hardness may be 20-30 Shore A hardness in some embodiments. In other embodiments, the hardness may be greater. Even with a low hardness, the molded foam biodegradable horticultural fill elements still exhibit structural properties in regard to supporting dirt or other plant growth matter in a container such as a planter. As discussed above, the resin may include oxidizing additives to accelerate biodegradation, and the amount of the oxidizing additive utilized may facilitate selection of the useful life and the period over which a foam horticultural fill element fully biodegrades.

In other embodiments manufacturing techniques such as blow-molding or extruding may be utilized, depending on the shape of the biodegradable horticultural fill element and other factors. As previously described, one or more oxidizing additive may be mixed with the resin used in these manufacturing processes to facilitate biodegradation and/or to facilitate selection of the period over which a foam horticultural fill element biodegrades.

### Example Natural Biodegradable Horticultural Fill Element

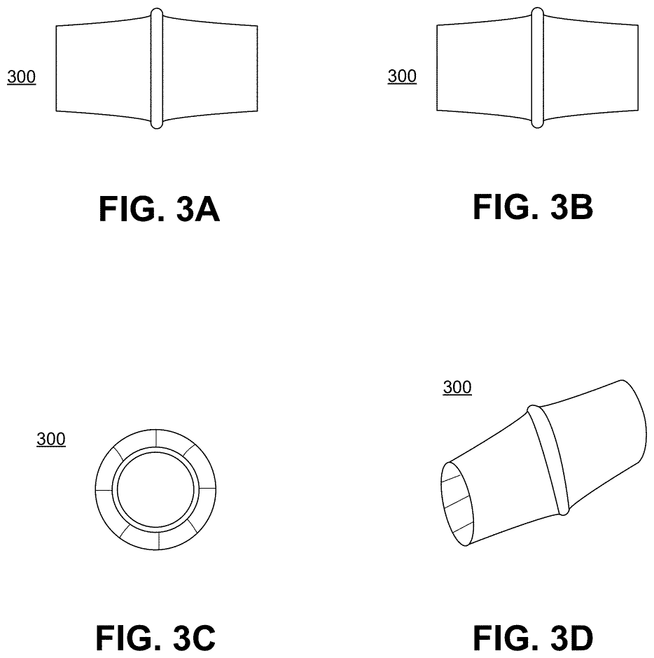

FIG. 3A illustrates a front elevational view of an example biodegradable horticultural fill element 300; the rear elevational view is the same. Biodegradable horticultural fill element 300 is a segment of bamboo.

FIG. 3B illustrates a top plan view of the example biodegradable horticultural fill element 300 shown in FIG. 3A; the bottom plan view is the same as FIG. 3B.

FIG. 3C illustrates a right side elevational view of the example biodegradable horticultural fill element 300 shown in FIG. 3A; the left side elevational view is the same as FIG. 3C.

FIG. 3D illustrates an upper front left perspective view of the example biodegradable horticultural fill element 300 shown in FIG. 3A.

Because bamboo is a natural product, the diameter of bamboo used in segments may vary even when a plurality of segments used as biodegradable horticultural fill element 300 are cut to the same length. In some embodiments, diameter may be between 0.5 inches and 4 inches and segments may be cut to lengths of between 1 inch and 6 inches. In some embodiments, a biodegradable horticultural fill element 300 may be hollow through and through. In other embodiments, a biodegradable horticultural fill element 300 may have a hollow portion or portions and one or more filled/solid cross-sectional portion (e.g., at the natural joint of the bamboo). The mostly hollow nature of bamboo ensures that biodegradable horticultural fill element 300 weighs substantially less than a volume of plant growth matter, such as dirt or potting soil, which it displaces. In some embodiments, the naturally hollow space within a bamboo segment used as a horticultural fill element may be filled with biodegradable plastic or foam to prevent or reduce water incursion into the filled space.

### Example Horticultural Fill Systems

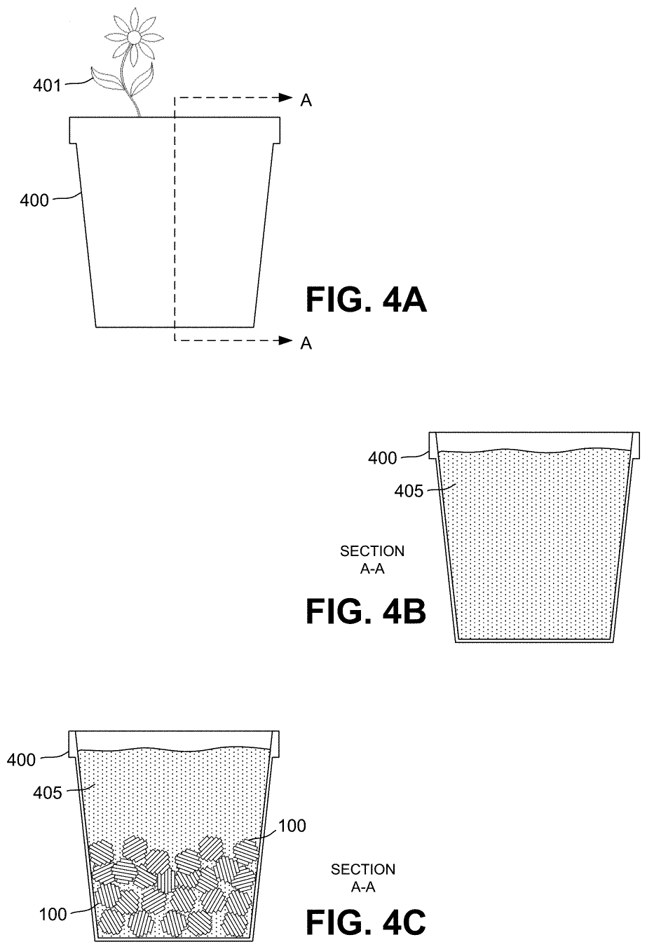

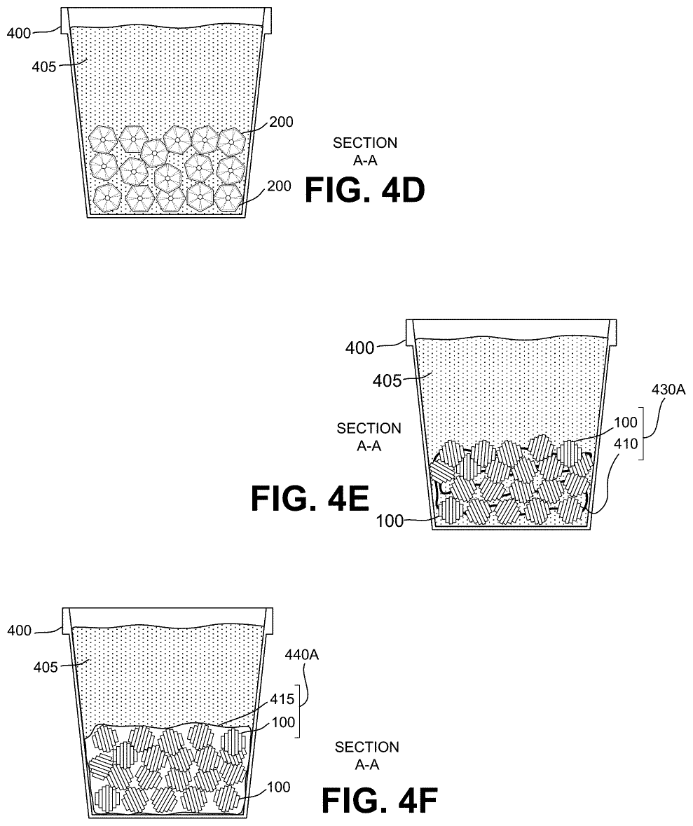

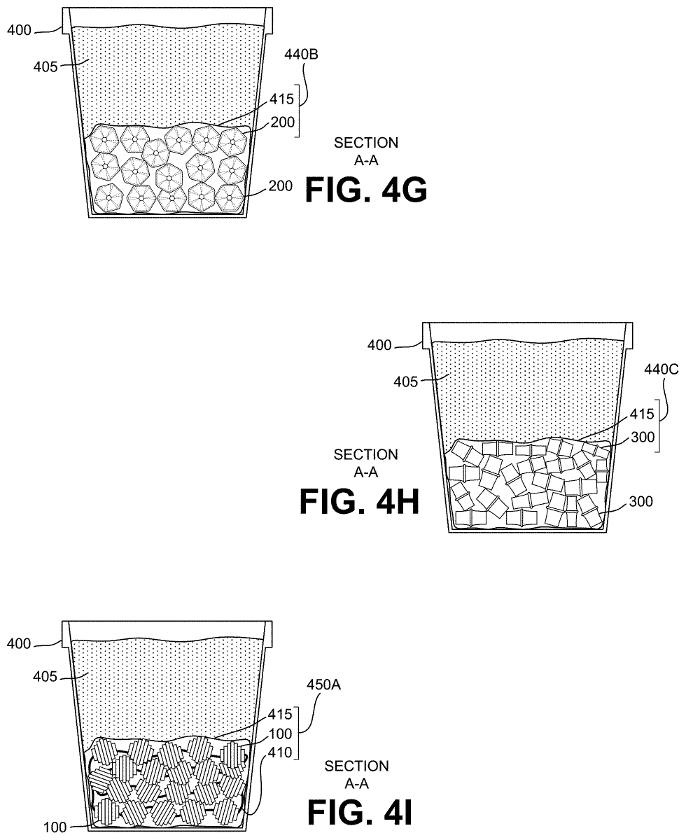

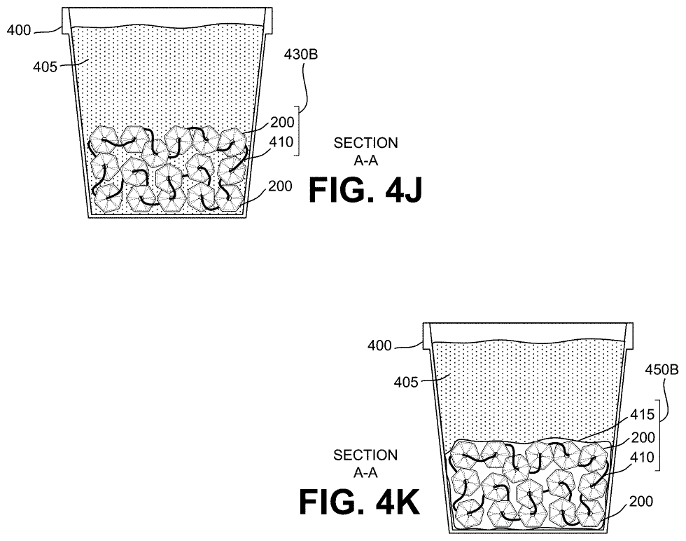

FIG. 4A illustrates a front elevational view of a horticultural planter container 400 with a flower 401 planted and growing in growth medium disposed within the horticultural planter container 400. Dashed section line A-A marks the location and direction of a sectional side view.

FIG. 4B illustrates one version of a left side elevational section A-A, in which the horticultural planter container 400 is filled entirely with growth matter 405 as may be done conventionally.

FIG. 4C illustrates a second version of a left side elevational section A-A, in which the horticultural planter container 400 is filled partially with a plurality of biodegradable horticultural fill elements 100 that are disposed loosely at the bottom of horticultural planter container 400. A layer of plant growth matter 405 is disposed above, and supported by, biodegradable horticultural fill elements 100.

Biodegradable horticultural fill elements 100 are used as to create a false bottom, within horticultural planter container 400, the space below which is filled (at least mostly) by the horticultural fill elements 100. In this manner horticultural fill elements 100 take the place of most or all of the plant growth medium which would normally occupy the space now filled by horticultural fill elements 100 in the lower portion of horticultural planter container 400. As depicted, the individual shapes of the biodegradable horticultural fill elements 100 may be identical in some embodiments. In other embodiments, one or more of the plurality of biodegradable horticultural fill elements 100 may have a different polyhedral shape from one or more of the others.

Referring still to FIG. 4C, the combined volume of these polyhedral biodegradable horticultural fill elements 100 comprises a support platform (the upper portion of which creates a false bottom of planter container 400) for supporting a volume of growth medium 405 such as soil for the growing of garden plants, flowers, etc. The space occupied by horticultural fill elements 100 promotes improved drainage which helps to prevent root rot and allows more oxygen to reach the plant(s) (e.g., flower 401) above. Using the biodegradable horticultural fill elements 100 in this manner allows the use of a lesser volume of growth medium 405, which decreases the use of water and fertilizer and also reduces the overall weight of the horticultural planter container 400 once planted. Water and fertilizer and/or nutrients are used more efficiently by being kept in contact with the roots of the plant(s) (e.g., flower 401) rather than migrating to the bottom of planter container 400 where few if any roots may reach. These efficiencies, in-turn, result in faster growing plants and healthier plants in comparison to plants in a planter container 400 which does not use the horticultural fill elements 100. Similarly, these efficiencies result in better growth and blooming versus plants in a planter container 400 which does not utilize the horticultural fill elements 100. In short, horticultural fill 100 facilitates flourishing plants.

FIG. 4D illustrates a third version of a left side elevational section A-A, in which the horticultural planter container 400 is filled partially with a plurality of biodegradable horticultural fill elements 200 that are disposed loosely at the bottom of horticultural planter container 400. A layer of plant growth matter 405 is disposed above, and supported by, biodegradable horticultural fill elements 200.

Biodegradable horticultural fill elements 200 are used as to create a false bottom, within horticultural planter container 400, the space below which is filled (at least mostly) by the horticultural fill elements 200. In this manner horticultural fill elements 200 take the place of most or all of the plant growth medium which would normally occupy the space now filled by horticultural fill elements 200 in the lower portion of horticultural planter container 400. As depicted, the individual shapes of the biodegradable horticultural fill elements 200 may be identical in some embodiments. In other embodiments, one or more of the plurality of biodegradable horticultural fill elements 200 may have a different polyhedral shape from one or more of the others.

Referring still to FIG. 4D, the combined volume of these polyhedral biodegradable horticultural fill elements 200 comprises a support platform (the upper portion of which creates a false bottom of planter container 400) for supporting a volume of growth medium 405 such as soil for the growing of garden plants, flowers, etc. The space occupied by horticultural fill elements 200 promotes improved drainage which helps to prevent root rot and allows more oxygen to reach the plant(s) (e.g., flower 401) above. Using the biodegradable horticultural fill elements 200 in this manner allows the use of a lesser volume of growth medium 405, which decreases the use of water and fertilizer and also reduces the overall weight of the horticultural planter container 400 once planted. Water and fertilizer and/or nutrients are used more efficiently by being kept in contact with the roots of the plant(s) (e.g., flower 401) rather than migrating to the bottom of planter container 400 where few if any roots may reach. This in-turn results in faster growing plants and healthier plants in comparison to plants in a planter container 400 which does not use the horticultural fill elements 200. Similarly, these efficiencies result in better growth and blooming versus plants in a planter container which does not utilize the horticultural fill elements 200. In short, horticultural fill 200 facilitates flourishing plants.

FIG. 4E illustrates a fourth version of a left side elevational section A-A, in which the horticultural planter container 400 is filled partially with a plurality of biodegradable horticultural fill elements 100 that are strung upon a biodegradable string 410 and disposed at the bottom of horticultural planter container 400. The combination of a plurality of biodegradable horticultural fill elements 100 and string 410 form a first horticultural fill system 430A embodiment. String 410 may be made of any biodegradable material. Some non-limiting examples include cotton string, hemp string, and biodegradable plastic string. String 410 is routed through the thru holes 130 of individual biodegradable horticultural fill elements 100, which become like beads on a necklace once strung. Strung in this manner, the biodegradable horticultural fill elements 100 may be easier to handle due to reduced likelihood of rolling away due to sloped ground, wind, being dropped, or being kicked. Being strung in this manner also facilitates quickly adding a predetermined number (the number selectively strung on the string 410) of biodegradable horticultural fill elements 100 to a certain sized horticultural planter container 400. Being strung in this manner also allows biodegradable horticultural fill elements 100 to be quickly separated from growth matter 405 at the end of a growing season.

The same plant benefits accrue from using strung horticultural fill elements 100 as from using loose horticultural fill elements 100.

FIG. 4F illustrates a fifth version of a left side elevational section A-A, in which the horticultural planter container 400 is filled partially with a plurality of biodegradable horticultural fill elements 100 that are confined within a bag 415 and disposed at the bottom of horticultural planter container 400. The combination of a plurality of biodegradable horticultural fill elements 100 and bag 415 (which may be biodegradable) form horticultural fill system 440A. Many of the previously described benefits accrue from using bagged horticultural fill elements 100, including, but not limited to: less growth medium, reduced weight of a planted container 400, more efficient use of water and nutrients, faster growing and healthier plants, and better growth and blooming.

FIG. 4G illustrates a sixth version of a left side elevational section A-A, in which the horticultural planter container 400 is filled partially with a plurality of biodegradable horticultural fill elements 200 that are confined within a bag 415 and disposed at the bottom of horticultural planter container 400. The combination of a plurality of biodegradable horticultural fill elements 200 and bag 415 (which may be biodegradable) form horticultural fill system 440B. Many of the previously described benefits accrue from using bagged horticultural fill elements 200, including, but not limited to: less growth medium, reduced weight of a planted container 400, more efficient use of water and nutrients, faster growing and healthier plants, and better growth and blooming.

FIG. 4H illustrates a seventh version of a left side elevational section A-A, in which the horticultural planter container 400 is filled partially with a plurality of biodegradable horticultural fill elements 300 that are confined within a bag 415 and disposed at the bottom of horticultural planter container 400. The combination of a plurality of biodegradable horticultural fill elements 300 and bag 415 (which may be biodegradable) form horticultural fill system 440C. Many of the previously described benefits, accrue from using bagged horticultural fill elements 300, including, but not limited to: less growth medium, reduced weight of a planted container 400, more efficient use of water and nutrients, faster growing and healthier plants, and better growth and blooming.

FIG. 4I illustrates an eighth version of a left side elevational section A-A, in which the horticultural planter container 400 is filled partially with a plurality of biodegradable horticultural fill elements 100 that are both strung on a biodegradable string 410 and confined within a bag 415 before being disposed at the bottom of horticultural planter container 400. The combination of a plurality of biodegradable horticultural fill elements 100, biodegradable string 410, and bag 415 form horticultural fill system 450A. Many of the previously described benefits, accrue from using bagged and strung horticultural fill elements 100, including, but not limited to: less growth medium, reduced weight of a planted container 400, more efficient use of water and nutrients, faster growing and healthier plants, and better growth and blooming.

FIG. 4J illustrates a ninth version of a left side elevational section A-A, in which the horticultural planter container 400 is filled partially with a plurality of biodegradable horticultural fill elements 200 that are strung upon a biodegradable string 410 and disposed at the bottom of horticultural planter container 400. The combination of a plurality of biodegradable horticultural fill elements 200 and string 410 form a second horticultural fill system 430B embodiment. String 410 may be made of any biodegradable material. Some non-limiting examples include cotton string, hemp string, and biodegradable plastic string. String 410 is routed through the thru holes which may be drilled into or formed into individual biodegradable horticultural fill elements 200, such that the elements 200 become like beads on a necklace once strung. Strung in this manner, the biodegradable horticultural fill elements 200 may be easier to handle due to reduced likelihood of rolling away due to sloped ground, wind, being dropped, or being kicked. Being strung in this manner also facilitates quickly adding a predetermined number (the number selectively strung on the string 410) of biodegradable horticultural fill elements 200 to a certain sized horticultural planter container 400. Being strung in this manner also allows biodegradable horticultural fill elements 100 to be quickly separated from growth matter 405 at the end of a growing season.

The same plant benefits accrue from using strung horticultural fill elements 200 as from using loose horticultural fill elements 200.

FIG. 4K illustrates tenth version of a left side elevational section A-A, in which the horticultural planter container 400 is filled partially with a plurality of biodegradable horticultural fill elements 200 that are both strung on a biodegradable string 410 and confined within a bag 415 before being disposed at the bottom of horticultural planter container 400. The combination of a plurality of biodegradable horticultural fill elements 200, biodegradable string 410, and bag 415 form horticultural fill system 450B. Many of the previously described benefits, accrue from using bagged and strung horticultural fill elements 200, including, but not limited to: less growth medium required to fill container 400, reduced weight of a planted container 400, more efficient use of water and nutrients, faster growing and healthier plants, and better growth and blooming.

With reference to FIGS. 4F, 4G, 4H, 4I and 4K and other depictions, in some embodiments, bag 415 may be made of any suitable plastic which may be waterproof or water resistant. In some embodiments, bag 415 may be made of any suitable biodegradable plastic material and may be oxo-biodegradable. In some embodiments, bag 415 may be designed to biodegrade in a predetermined number of years after production, such as 2 years, 3 years, 10 years, 20 years, etc. or a range of years such as between 5 and 20 years after production of the bag. The time span of the biodegradation of bag 415 may be the same as, shorter than, or longer than the designed biodegradation time span of full biodegradation of the plurality of biodegradable horticultural fill elements (e.g., 100, 200, 300) which are disposed within it. In some embodiments, bag 415 may be made of cloth, burlap, paper, or other materials(s). In some embodiments, bag 415 is not made of plastic or not exclusively made of plastic. In some embodiments, bag 415 is not biodegradable. Bagged in this manner, in bag 415, the biodegradable horticultural fill elements (100, 200, 300, etc.) may be easier to handle due to reduced likelihood of rolling away due to sloped ground, wind, being dropped, or being kicked. Being bagged in this manner also facilitates quickly adding a predetermined number (the number selectively bagged in bag 415) of the biodegradable horticultural fill elements (100, 200, 300, etc.) to a certain sized horticultural planter container 400. Being bagged in this manner also allows the biodegradable horticultural fill elements (100, 200, 300, etc.) to be quickly separated from growth matter 405 at the end of a growing season, this encourages and facilitates reusability of the biodegradable horticultural fill elements. Being bagged in this manner also allows the biodegradable horticultural fill elements (100, 200, 300, etc.) to be remain clean and free of growth matter 405, which may reduce cleanup time at the end of a growing season.

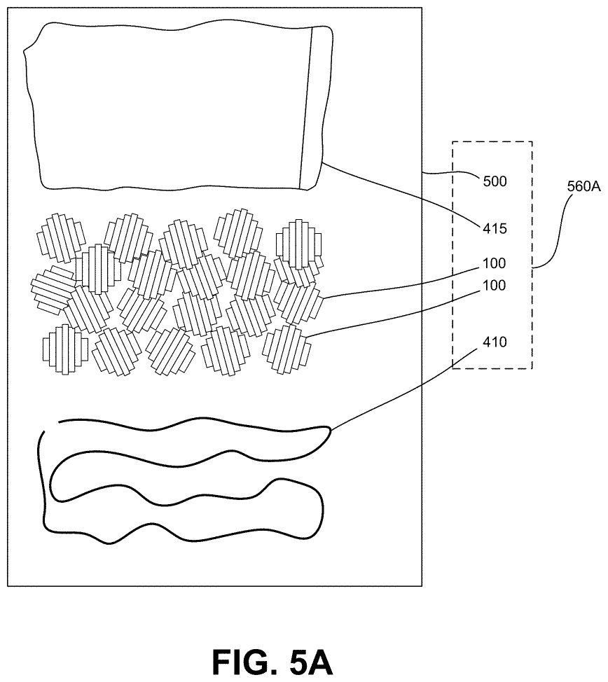

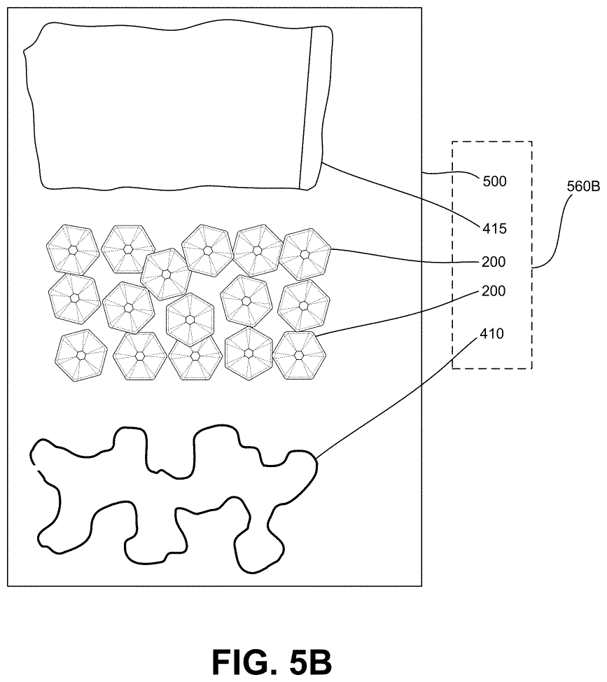

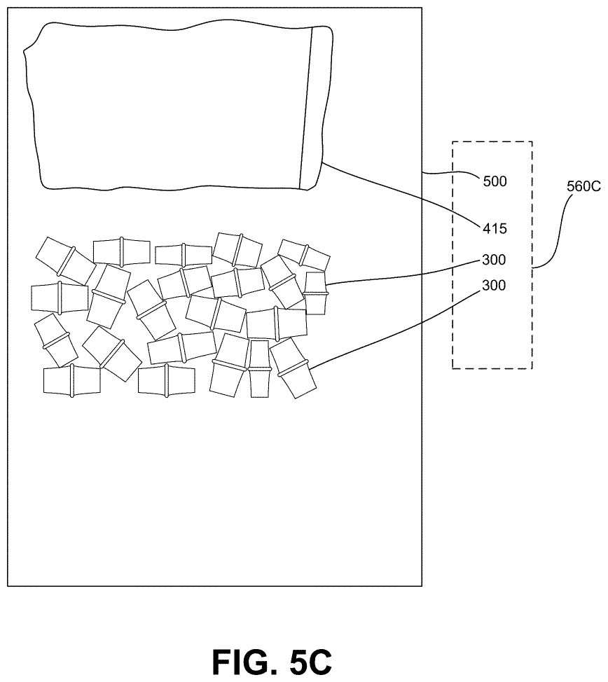

FIG. 5A illustrates a top plan view of recyclable or biodegradable outer packaging 500 which contains a plurality of biodegradable horticultural fill elements 100 along with one or more of a biodegradable string 410 and a bag 415 to form a stock-keeping unit (SKU). This SKU forms a horticultural fill system 560A embodiment which may be sold as a wholesale unit or a retail unit. In addition to sales packaging, biodegradable outer packaging 500 may provide a convenient storage vessel for biodegradable horticultural fill elements 100 along with one or more of a biodegradable string 410 and a bag 415 when these items are not being used.

FIG. 5B illustrates a top plan view of recyclable or biodegradable outer packaging 500 which contains a plurality of biodegradable horticultural fill elements 200 along with one or more of a biodegradable string 410 and a bag 415 to form a stock-keeping unit (SKU). This SKU forms a horticultural fill system 560B embodiment which may be sold as a wholesale unit or a retail unit. In addition to sales packaging, biodegradable outer packaging 500 may provide a convenient storage vessel for biodegradable horticultural fill elements 200 along with one or more of a biodegradable string 410 and a bag 415 when these items are not being used.

FIG. 5C illustrates a top plan view of recyclable or biodegradable outer packaging 500 which contains a plurality of biodegradable horticultural fill elements 300 along with a bag 415 to form a stock-keeping unit (SKU). This SKU forms a horticultural fill system 560C embodiment which may be sold as a wholesale unit or a retail unit. In addition to sales packaging, biodegradable outer packaging 500 may provide a convenient storage vessel for biodegradable horticultural fill elements 300 along with one or more of a biodegradable string 410 and a bag 415 when these items are not being used.

### Coated/Treated Horticultural Fill Elements

In some embodiments, one or more of horticultural fill elements (100, 200, 300, etc.) may be coated with one or more coatings or treatments which dissolve slowly into plant growth medium and/or are absorbed by plant roots. For example, a coating may include, but is not limited to, one or more of: a plant food; an insecticide, a nematicide, a fungicide, a herbicide (i.e., a pre-emergent herbicide to prevent germination of weeds or non-desired plants); a root treatment; a nutrient, and a fertilizer. The coating or treatment is a substance which facilitates growth and/or thriving of a plant. Coatings/treatments may be tailored to different types of plants. For example, horticultural fill elements manufactured for use with roses may be coated/treated with a different nutrients than horticultural fill elements manufactured for use with tomato plants.

### Alternative Embodiments of Biodegradable Horticultural Fill Elements

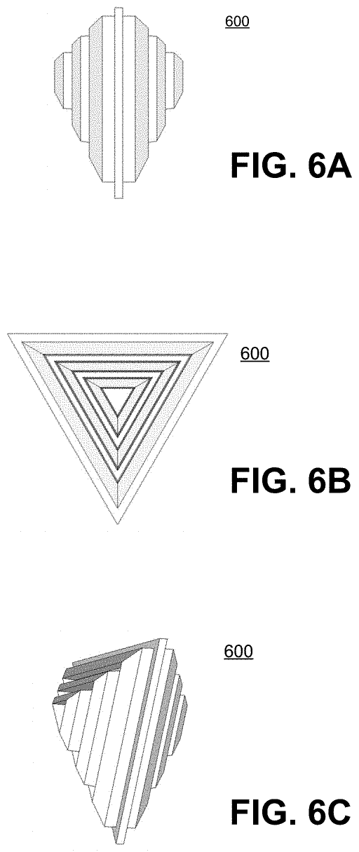

FIGS. 6A-6C show an example triangular polyhedral biodegradable horticultural fill element 600 which may be used in conjunction with or in place of horticultural fill element(s) 100, 200, and/or 300 in embodiments described herein. A biodegradable horticultural fill element 600 may be manufactured in any suitable manner, including using any of the oxy-biodegradable plastics and manufacturing techniques described herein.

FIG. 6A illustrates a front elevational view of an example biodegradable horticultural fill element 600. The rear elevational view is the same.

FIG. 6B illustrates a right side elevational view of the example biodegradable horticultural fill element 600 shown in FIG. 6A. The left side elevational view is the same as FIG. 6B.

FIG. 6C illustrates an upper front right perspective view of the example biodegradable horticultural fill element 600 shown in FIG. 6A. The upper front left perspective view is a mirror image of FIG. 6C.

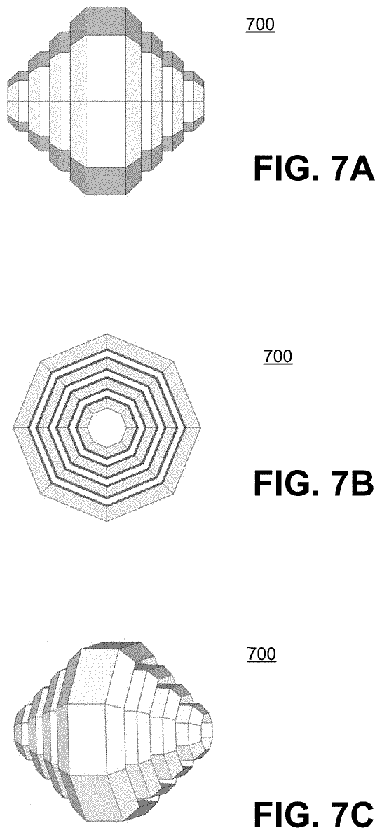

FIGS. 7A-7C show an example octagonal polyhedral biodegradable horticultural fill element 700 which may be used in conjunction with or in place of horticultural fill element(s) 100, 200, and/or 300 in embodiments described herein. A biodegradable horticultural fill element 700 may be manufactured in any suitable manner, including using any of the oxy-biodegradable plastics and manufacturing techniques described herein.

FIG. 7A illustrates a front elevational view of an example biodegradable horticultural fill element 700. The rear elevational view is the same.

FIG. 7B illustrates a right side elevational view of the example biodegradable horticultural fill element 700 shown in FIG. 7A. The left side elevational view is the same as FIG. 7B.

FIG. 7C illustrates an upper front right perspective view of the example biodegradable horticultural fill element 700 shown in FIG. 7A. The upper front left perspective view is a mirror image of FIG. 7C.

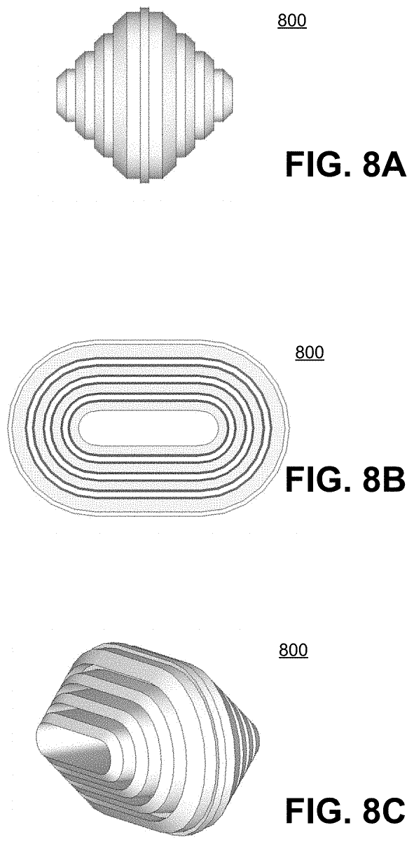

FIGS. 8A-8C show an example oval polyhedral biodegradable horticultural fill element 800 which may be used in conjunction with or in place of horticultural fill element(s) 100, 200, and/or 300 in embodiments described herein. A biodegradable horticultural fill element 800 may be manufactured in any suitable manner, including using any of the oxy-biodegradable plastics and manufacturing techniques described herein.

FIG. 8A illustrates a front elevational view of an example biodegradable horticultural fill element 800. The rear elevational view is the same.

FIG. 8B illustrates a right side elevational view of the example biodegradable horticultural fill element 800 shown in FIG. 8A. The left side elevational view is the same as FIG. 8B.

FIG. 8C illustrates an upper front right perspective view of the example biodegradable horticultural fill element 800 shown in FIG. 8A. The upper front left perspective view is a mirror image of FIG. 8C.

### CONCLUSION

The examples set forth herein were presented in order to best explain, to describe particular applications, and to thereby enable those skilled in the art to make and use embodiments of the described examples. However, those skilled in the art will recognize that the foregoing description and examples have been presented for the purposes of illustration and example only. The description as set forth is not intended to be exhaustive or to limit the embodiments to the precise form disclosed. Rather, the specific features and acts described above are disclosed as example forms of implementing the claims.

Reference throughout this document to “one embodiment,” “certain embodiments,” “an embodiment,” “various embodiments,” “some embodiments,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics of any embodiment may be combined in any suitable manner with one or more other features, structures, or characteristics of one or more other embodiments without limitation.

What is claimed is:

1. A horticultural fill system comprising:
a biodegradable outer packaging; and
a plurality of biodegradable bipyramidal horticultural fill elements removably disposed within the biodegradable outer packaging; and
wherein a group of the plurality of biodegradable bipyramidal horticultural fill elements is configured to be positioned in a horticultural planter container, as horticultural fill, beneath growth medium in which a plant is to be grown.

2. The horticultural fill system of claim 1, further comprising:
a bag disposed within biodegradable outer packaging, wherein the group of the plurality of biodegradable bipyramidal horticultural fill elements is configured to be removed from the biodegradable outer packaging and disposed within the bag with the bag sealed and disposed beneath the growth medium in the horticultural planter container.

3. The horticultural fill system of claim 2, further comprising:
a biodegradable string disposed within the biodegradable outer packaging, wherein the group of the plurality of biodegradable bipyramidal horticultural fill elements is further configured to be strung upon a biodegradable string routed through central thru holes in each of the elements of the group of the plurality of biodegradable bipyramidal horticultural fill elements and disposed within the bag beneath the growth medium in the horticultural planter container.

4. The horticultural fill system of claim 2, wherein the bag comprises a composition selected to facilitate biodegradation of the bag within a preselected time period of between 5 and 20 years from production of the bag.

5. The horticultural fill system of claim 1, further comprising:
a biodegradable string disposed within the biodegradable outer packaging, wherein the group of the plurality of biodegradable bipyramidal horticultural fill elements is configured to be strung upon a biodegradable string routed through central thru holes in each of the group of the plurality of biodegradable bipyramidal horticultural fill elements and disposed beneath the growth medium in the horticultural planter container.

6. The horticultural fill system of claim 1, wherein a biodegradable bipyramidal horticultural fill element of the plurality of biodegradable bipyramidal horticultural fill elements comprises:
a structure formed of oxo-biodegradable plastic.

7. The horticultural fill system of claim 1, wherein a biodegradable bipyramidal horticultural fill element of the plurality of biodegradable bipyramidal horticultural fill elements comprises:
a structure formed of internal foam with an outer skin.

8. The horticultural fill system of claim 1, wherein a biodegradable bipyramidal horticultural fill element of the plurality of biodegradable bipyramidal horticultural fill elements comprises:
one or more additives selected to choose a time span over which the biodegradable bipyramidal horticultural fill element will have a useful life after production and before beginning to biodegrade enough that it cannot be readily used for its purpose.

9. The horticultural fill system of claim 1, wherein a biodegradable bipyramidal horticultural fill element of the plurality of biodegradable bipyramidal horticultural fill elements comprises:
a coating with a substance which promotes one of plant growth and thriving.

10. A horticultural fill system comprising:
a bag; and
a plurality of biodegradable bipyramidal horticultural fill elements; and
wherein a group of the plurality of biodegradable bipyramidal horticultural fill elements is configured to be disposed within the bag with the bag sealed and positioned in a horticultural planter container, as horticultural fill, beneath growth medium in which a plant is to be grown.

11. The horticultural fill system of claim 10, further comprising:
a biodegradable string, wherein the group of the plurality of biodegradable bipyramidal horticultural fill elements is configured to be strung upon a biodegradable string routed through central thru holes in each of the elements of the group of the plurality of biodegradable bipyramidal horticultural fill elements and disposed within the bag beneath the growth medium in the horticultural planter container.

12. The horticultural fill system of claim 10, wherein the bag comprises a composition selected to facilitate biodegradation of the bag within a preselected time period of between 5 and 20 years from production of the bag.

13. The horticultural fill system of claim 10, wherein a biodegradable bipyramidal horticultural fill element of the plurality of biodegradable bipyramidal horticultural fill elements comprises:
a structure formed of oxo-biodegradable plastic.

14. The horticultural fill system of claim 10, wherein a biodegradable bipyramidal horticultural fill element of the plurality of biodegradable bipyramidal horticultural fill elements comprises:
a structure formed of internal foam with an outer skin.

15. The horticultural fill system of claim 10, wherein a biodegradable bipyramidal horticultural fill element of the plurality of biodegradable bipyramidal horticultural fill elements comprises:
one or more additives selected to choose a time span over which the biodegradable bipyramidal horticultural fill element will have a useful life after production and before beginning to biodegrade enough that it cannot be readily used for its purpose.

16. The horticultural fill system of claim 10, wherein a biodegradable bipyramidal horticultural fill element of the plurality of biodegradable bipyramidal horticultural fill elements comprises:
a coating with a substance which promotes one of plant growth and thriving.

17. A biodegradable horticultural fill element comprising:
a polyhedron formed of a plastic resin; and
at least one additive disposed in the plastic resin and configured to oxidize the plastic resin, wherein the at least one additive is selected to define a time span of full biodegradation of the plastic resin.

18. The biodegradable horticultural fill element of claim 17, wherein the polyhedron comprises an internal foam with an outer skin.

19. The biodegradable horticultural fill element of claim 17, wherein the polyhedron is a bipyramidal shaped polyhedron.

20. The biodegradable horticultural fill element of claim 19, wherein the polyhedron defines a thru hole between a first vertex of a first pyramid of the bipyramidal shaped polyhedron and a second vertex of a second pyramid of the bipyramidal shaped polyhedron.
